(19) United States
(12) Patent Application Publication
(10) Pub. No.: US 2025/0189865 A1
(43) Pub. Date: Jun. 12, 2025

(54) KERR PHOTONIC CRYSTAL RESONATORS FOR CONTINUOUSLY-TUNABLE AND WAVELENGTH-ACCURATE NONLINEAR CONVERSION AND METHODS THEREOF

(71) Applicants: University of Maryland, College Park, College Park, MD (US); Government of the United States of America, as Represented by the Secretary of Commerce, Gaithersburg, MD (US)

(72) Inventors: Jordan Stone, Rockville, MD (US); Kartik Srinivasan, Rockville, MD (US); Xiyuan Lu, Montgomery Village, MD (US)

(21) Appl. No.: 18/951,849

(22) Filed: Nov. 19, 2024

Related U.S. Application Data
(60) Provisional application No. 63/608,769, filed on Dec. 11, 2023.

(51) Int. Cl. G02F 1/365

(52) U.S. Cl. CPC G02F 1/365

(57) ABSTRACT

A system for wavelength-accurate conversion includes a light source configured to pump a first color laser light and a device configured for Kerr-nonlinear wavelength conversion of the first color laser light to a signal laser light and an idler laser light, the device includes: a waveguide configured to couple to the light source; and a microring resonator coupled to the light source via the waveguide. The microring resonator configured to generate the signal laser light and the idler laser light. The microring resonator including a plurality of projections. A number of the projections is linked to a targeted output wavelength for at least one of the signal laser light or the idler laser light, and a refractive index grating strength of each projection of the plurality of projections is linked to a frequency mismatch between modes when comparing to a reference device lacking the plurality of projections.

### CROSS-REFERENCE TO RELATED APPLICATION AND CLAIM OF PRIORITY

This application claims the benefit of, and priority to, U.S. Provisional Patent Application No. 63/608,769, filed on Dec. 11, 2023, the entire contents of which are hereby incorporated herein by reference.

### GOVERNMENT SUPPORT

This invention was made with government support under HR0011-20-2-0046 awarded by the Defense Advanced Research Projects Agency, and 70NANB16H168 awarded by the National Institute of Standards and Technology. The government has certain rights in the invention.

### TECHNICAL FIELD

The subject matter of the present disclosure relates generally to parametric nonlinear systems and methods. More particularly, the subject matter of the present disclosure relates to nonlinear wavelength converters and their method of operation for the transfer of optical energy from lasers or other classical or quantum light source (such as those based on quantum emitters) to other useful colors while providing output wavelengths that are accurately controlled.

### BACKGROUND

Integrated nonlinear wavelength converters transfer optical energy from lasers or (such as those based on quantum emitters) to other useful colors, but chromatic dispersion limits the range of achievable wavelength shifts. Moreover, because of geometric dispersion, fabrication tolerances reduce the accuracy with which wavelength-converting devices produce specific target wavelengths. Accordingly, there remains a need for nonlinear wavelength converters and alternative operations thereof that do not exhibit these characteristics when incorporated in devices.

### SUMMARY

In accordance with aspects of the disclosure, a system for wavelength-accurate conversion includes: a light source configured to pump a first color laser light and a device configured for Kerr-nonlinear wavelength conversion of the first color laser light to a signal laser light and an idler laser light. The device includes a waveguide configured to couple to the light source and a microring resonator coupled to the light source via the waveguide, the microring resonator configured to generate the signal laser light and the idler laser light, the microring resonator including a plurality of surfaces. At least one of the plurality of surfaces includes a plurality of projections. A number of the projections is linked to a targeted output wavelength for at least one of the signal laser light or the idler laser light, a refractive index grating strength of each projection of the plurality of projections is linked to a frequency mismatch between modes when compared to a reference device lacking the plurality of projections.

In an aspect of the present disclosure, at least one of the plurality of surfaces may include: an inner surface defining an annular bore; an outer surface opposite the inner surface; a top surface; and a bottom surface opposite the top surface and disposed on a substrate.

In another aspect of the present disclosure, the plurality of projections may radially project from the inner surface. The plurality of projections may define an angle between each projection of the plurality of projections. The angle between each projection of the plurality of projections may be two times pi times a radius of the microring resonator divided by a number of the plurality of projections (N).

In yet another aspect of the present disclosure, the plurality of projections may be configured to create a refractive index grating that coherently couples clockwise (CW) and counterclockwise (CCW) traveling-wave modes with an azimuthal number m=N/2, where m is an integer related to a wavenumber k via k=m/R. The coherent coupling may introduce a frequency splitting of the CW and CCW modes with azimuthal number m by an amount 2 J.

In a further aspect of the present disclosure, the azimuthal number m is selected based on the targeted output wavelength of the Kerr-nonlinear wavelength conversion linking the targeted output wavelength to the number of the plurality of projections (N).

In yet a further aspect of the present disclosure, the refractive index grating strength may be linked to the frequency spitting 2 J, and is chosen to compensate for the frequency mismatch between the modes involved in the Kerr-nonlinear wavelength conversion process when compared to a reference device lacking the plurality of projections.

In accordance with aspects of the disclosure, the plurality of projections may project radially outward from at least one of the outer surface or the top surface.

In an aspect of the present disclosure, the system may further include a heater configured for tuning a frequency of the signal laser light.

In another aspect of the present disclosure, the system may be configured for performing at least one of: four-wave mixing Bragg scattering, third harmonic generation, dispersive wave emission in microresonator frequency combs, third-order sum and difference frequency generation, stimulated four-wave mixing, DC-field-induced second harmonic generation, second-order (chi(2)) nonlinear processes, including at least one of second harmonic generation, sum and difference frequency generation, or chi(2) OPO.

An aspect of the present disclosure provides a device for wavelength-accurate conversion including a waveguide configured to couple to a light source and a microring resonator coupled to the light source via the waveguide. The microring resonator is configured to generate a signal laser light and an idler laser light. The microring resonator includes a plurality of surfaces. At least one of the plurality of surfaces includes a plurality of projections. A number of the projections is linked to a targeted output wavelength for at least one of the signal laser light or the idler laser light, and a refractive index grating strength of each projection of the plurality of projections is linked to a frequency mismatch between modes when compared to a reference device lacking the plurality of projections.

In a further aspect of the present disclosure, the plurality of projections may be configured to create a refractive index grating that coherently couples clockwise (CW) and counterclockwise (CCW) traveling-wave modes with an azimuthal number m=N/2, where m is an integer related to a wavenumber k via k=m/R. The coherent coupling may introduce a frequency splitting of the CW and CCW modes with azimuthal number m by an amount 2 J.

In yet a further aspect of the present disclosure, the azimuthal number m may be selected based on the targeted output wavelength of the Kerr-nonlinear wavelength conversion linking the targeted output wavelength to the number of the plurality of projections (N).

In another aspect of the present disclosure, the refractive index grating strength may be linked to the frequency spitting 2 J, and may be chosen to compensate for the frequency mismatch between the modes involved in the Kerr-nonlinear wavelength conversion process when compared to a reference device lacking the plurality of projections.

An aspect of the present disclosure provides a method for wavelength-accurate conversion, including: receiving by a waveguide a first color laser light from a laser source; coupling the laser source to a microring resonator via the waveguide, the microring resonator including a plurality of surfaces. At least one of the plurality of surfaces includes a plurality of projections; perform Kerr-nonlinear wavelength conversion of the first color laser light to a signal laser light and an idler laser light; linking a number of projections of the plurality of projections to a targeted output wavelength for at least one of the signal laser light or the idler laser light; and linking a refractive index grating strength of each projection of the plurality of projections to a frequency mismatch between modes when compared to a reference device lacking the plurality of projections.

In a further aspect of the present disclosure, the plurality of projections may radially project from an inner surface of the microring resonator. The plurality of projections may define an angle between each projection of the plurality of projections. The angle between each projection of the plurality of projections may be two times pi times a radius of the microring resonator divided by a number of the plurality of projections.

In yet a further aspect of the present disclosure, the method may further include coherently coupling clockwise (CW) and counterclockwise (CCW) traveling-wave modes with an azimuthal number m=N/2, where m is an integer related to a wavenumber k via k=m/R. The coherent coupling introduces a frequency splitting of the CW and CCW modes with azimuthal number m by an amount 2 J.

In another aspect of the present disclosure, the plurality of projections project radially outward from at least one of an outer surface or a top surface of the microring resonator.

In yet another aspect of the present disclosure, the method may further include tuning a frequency of the signal laser light by a heater configured to heat the microring resonator.

In a further aspect of the present disclosure, the method may further include using the microring resonator to perform at least one of: four-wave mixing Bragg scattering, third harmonic generation, dispersive wave emission in microresonator frequency combs, third-order sum and difference frequency generation, stimulated four-wave mixing, DC-field-induced second harmonic generation, second-order (chi(2)) nonlinear processes, including at least one of second harmonic generation, sum and difference frequency generation, or chi(2) OPO.

In yet a further aspect of the present disclosure, the method may further include selecting the azimuthal number m based on the targeted output wavelength of the Kerr-nonlinear wavelength conversion process linking the targeted output wavelength to the number of the plurality of projections (N).

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of an exemplary device for generating a coherent laser light, in accordance with examples of the present disclosure;

FIGS. 2A-2C are graphs illustrating non-linear wavelength conversion in Kerr photonic crystal microresonators of the system of FIG. 1, in accordance with examples of the present disclosure;

FIG. 3 is a graph illustrating optical spectra generated using the microresonators of FIG. 1 having different numbers of projections, in accordance with examples of the present disclosure;

FIG. 4A is a graph showing a transmission spectrum illustrating the frequency splitting of a travelling-wave mode (grey dashed line) into two standing-wave supermodes with frequency separation 2 J, in accordance with examples of the present disclosure;

FIG. 4B shows graphs illustrating simulated Δv spectra of an OPOSSUM device in the CW/CCW basis (left), the ‘+’ basis (center) and the ‘−’ basis (right), in accordance with examples of the present disclosure;

FIG. 4C is a graph illustrating Δv+ versus pump wavelength for an OPOSSUM device with R=25 μm, RW=925 nm, in accordance with examples of the present disclosure;

FIG. 4D is a graph illustrating optical spectra obtained from pumping four different modes (with wavelengths between 768 nm and 774 nm) in the device of FIG. 1, in accordance with examples of the present disclosure;

FIG. 4E is a graph illustrating transmission spectrum of the device of FIG. 1, in accordance with examples of the present disclosure;

FIG. 4F is a graph illustrating signal and idler frequencies versus pump wavelength, in accordance with examples of the present disclosure;

FIG. 5A shows graphs illustrating the optical spectrum calibrated to indicate the on-chip power of the system of FIG. 1, in accordance with examples of the present disclosure;

FIG. 5B is a graph illustrating the measured threshold power (Pₜₕ) versus Δv+, for the system of FIG. 1, in accordance with examples of the present disclosure;

FIG. 5C is a graph illustrating idler conversion efficiency (Pᵢ/Pᵢₙ) versus normalized J, in accordance with examples of the present disclosure;

FIG. 6A is a graph illustrating vᵢ versus vₚ at eleven different temperatures for the system of FIG. 1, in accordance with examples of the present disclosure; and

FIG. 6B shows graphs illustrating optical spectra for eleven different temperatures for the system of FIG. 1, in accordance with examples of the present disclosure.

### DETAILED DESCRIPTION

The present disclosure relates generally to parametric nonlinear systems and methods. More specifically, the present disclosure relates to systems and methods for wavelength-accurate conversion using Kerr photonic crystal resonators.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Controlling integrated microsystems to generate light with properties that are specifically geared to applications is a fundamental ambition of photonics research. For example, optical atomic clocks require ultra-coherent laser light with wavelengths precisely matched to atomic transitions, and future hybrid quantum networks will interface sources of non-classical light (for example, single photons) tuned to qubit wavelengths. A powerful tool to meet the demands of such systems is optical nonlinearity, which can mold light on a quantum level and stimulate wavelength conversion (for example, through four-wave mixing (FWM)) for spectral access beyond conventional laser gain. In particular, optical microresonators with Kerr (χ⁽³⁾) nonlinearity have, after multiple groundbreaking demonstrations, become a linchpin of nonlinear photonics. They support microcombs for frequency synthesis, timekeeping and sensing; optical parametric oscillators (μOPOs) for wavelength-flexible sources of laser light, squeezed light and entangled photon pairs; four-wave mixing Bragg scattering (FWM-BS) for spectral translation of single photons; third-harmonic generation (THG); and more.

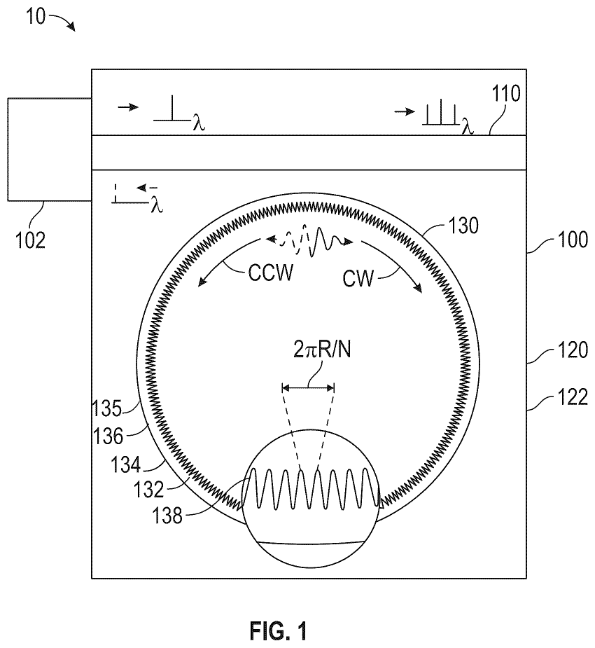

Referring to FIG. 1, a diagram of an exemplary system 10 and device 100 for wavelength-accurate conversion, are shown. The device 100 is configured for on-chip coherent light generation. The device 100 provides the benefit of enabling wavelength-accurate conversion with small device footprints.

The system 10 may include a light source 102 (e.g., pump) configured to pump a first color laser light and a device 100 configured to generate a coherent second color light (i.e., signal) and a coherent third color light (i.e., idler). The device 100 generally includes a waveguide 110, and a microring resonator 130 (e.g., a microresonator) configured to generate signal and idler light in response to the first color laser light. The microring resonator 130 may include a photonic crystal patterning to create a photonic crystal ring (PhCR). The microring resonator 130 may be composed of rods to create a rod photonic crystal ring (rPhCR) or may include a series of slits to form a slit photonic crystal ring (sPhCR). The microring resonator 130 enables access to an output frequency that is significantly different than that produced by the light source 102 (e.g., a Fabry-Perot laser chip).

The signal light is a different color than the first color laser light. The idler light is a different color than the first color laser light. The signal light is a different color than the idler laser light. The waveguide 110 is configured to couple the light source 102 to the microring resonator 130. The waveguide 110 may be comprised of, for example, silicon nitride and/or silicon oxynitride or other such suitable materials.

The microring resonator 130 generally includes a layer comprised of silicon nitride (Si₃N₄) on a first side of a substrate 122 comprised of silicon dioxide (SiO₂). It is contemplated that other suitable materials may be used for the substrate 122 and for the microring resonator layer 130. For example, the layer 130 material may lithium niobate, aluminum nitride, tantalum pentoxide, silicon, and gallium arsenide. The material choice is informed by the requirement of optical transparency across the wavelengths of operation and a refractive index that is larger than that of the substrate 122. Alternative substrate materials include sapphire, quartz, MgF₂, or any material with optical transparency across the wavelengths of operation and whose refractive index is lower than that of the microring layer 130. The layer includes a ring width (RW) which can be configured for tuning the microring resonator 130, a ring radius (RR), and a height (H). The microring resonator 130 includes a plurality of modes selected from different families of modes. The modes are typically either transverse-electric-like (TE) or transverse-magnetic-like (TM). In aspects, the microring resonator 130 may further include a layer of silicon (Si) disposed on a second side of the substrate 122. Other material stack-ups are contemplated. In aspects, the microring resonator 130 and the waveguide 110 may be either on the same layer or on different layers of a common substrate 122. Moreover, the microring and waveguide layers may be surrounded by a lower refractive index material other than air (another solid cladding layer; not shown).

The microring resonator 130 includes a plurality of surfaces. Each or at least one of the plurality of surfaces includes an inner surface 132 defining an annular bore; an outer surface 135 opposite the inner surface 132; a top surface 136; and a bottom surface 135 opposite the top surface 136 and disposed on the substrate 122. The plurality of surfaces of microring resonator 130 includes a grating (e.g., a plurality of projections).

The microring resonator 130 may further include a heater 120 configured for tuning of the microring resonator 130. Heater 120 may be comprised of a conductive strip (e.g., a platinum (Pt)) strip buried in the silicon dioxide (SiO₂) substrate 122 below the SiN layer.

For example, intraresonator FWM converts pump energy into signal and idler waves with widely separated frequencies, and all three waves are resonant with fundamental transverse electric modes, so that temperature changes that shift the mode spectrum are conveyed to the OPO spectrum. Heat is transferred to the microring by driving current through a Pt strip buried in the substrate about 3 μm below the SiN layer. The microring resonator 130 has a thermal tuning coefficient for a resonator mode. This coefficient may be different for each resonator mode. As the effective temperature of the microring resonator 130 is increased, the microring dispersion changes (primarily due to the chromatic dispersion of the thermo-optic coefficient) and eventually prevents oscillation when pumping a given mode.

Stabilization may be performed by using feedback. For example, the idler frequency may be detected by a detector (e.g., a Mach-Zehnder interferometer).

For example, the system 10 output may be filtered to isolate the idler wave and a fiber Mach-Zehnder interferometer may be used to transduce vᵢ fluctuations into optical power fluctuations that are detected with a transimpedance-amplified photodiode whose output serves as an error signal. The error signal may be processed (e.g., using a PID) and used to generate a control voltage for the heater 130.

Without feedback, the dominant contribution to Sᵢᵢ at offset frequencies less than about 1 kHz is pump laser frequency noise. Above this frequency, intrinsic thermorefractive noise plays a large role. With feedback, the system 10 reduces Sᵢᵢ by more than six orders of magnitude at low offset frequencies, and noise suppression is observed at offset frequencies up to 5 kHz. Notably, V feedback does not influence vₚ. Integrated heating via heater 120 increases the range of continuous frequency tuning to over 1.5 THz, and feedback provided in system 10 enables substantial broadband noise reduction.

Energy and momentum conservation regulate FWM. Therefore, to within (approximately) a resonator linewidth, a set of resonator modes should obey:

$${\sum }_{i} {v}_{i} = {\sum }_{j} {v}_{j} , \qquad ( 1 )$$

$${\sum }_{i} {m}_{i} = {\sum }_{j} {m}_{j} , \qquad ( 2 )$$

where mᵢ is the azimuthal number (fundamentally related to the wave-number) associated with a resonator mode with frequency vᵢ, and the left-hand (right-hand) terms denote photons created (annihilated) during the FWM process. The pair of equations (1) and (2) is exact when vᵢ and mᵢ refer to field quantities. In general, group velocity dispersion (GVD) induces a frequency mismatch, such that a set of modes satisfying equation (2) does not simultaneously satisfy equation (1). The strategic ‘dispersion engineering’ of modes to satisfy both equations (1) and (2) is ubiquitous in guided-wave nonlinear photonics, with the most popular approach being to complement material dispersion with dispersion arising from the microresonator geometry. However, modeling broadband spectra, such as octave-spanning microcombs or OPOs with widely separated wavelengths, often requires retaining six or more orders in a Taylor expansion of vᵢ(mᵢ) around the pump wavelength. In this regime, the mode wavelengths that satisfy both equations (1) and (2) are extremely sensitive to geometry. Hence, small errors in the device geometry (arising from either fabrication uncertainties or incomplete modeling) can amount to substantial differences between the simulated and experimentally observed spectrum. This necessitates the fabrication of many (often, hundreds or more) devices with nanometer-scale parameter variations. Ultimately, one negotiates a trade-off between the number of devices that require testing and the dispersion tolerance of a given application. In many cases, a simple geometry-based solution to realize a particular GVD (for example, one based on controlling the dimensions of a waveguide) does not exist. To make matters worse, unwanted nonlinear couplings (for example, Raman scattering, mode competition, and so on) can compete with or even suppress the targeted process.

Thus, demonstrating Kerr-nonlinear wavelength conversion for which the m values of participating resonator modes are guaranteed from design. However, the present disclosure provides the benefit of alleviating design constraints, naturally suppresses unwanted nonlinear couplings and does not rely on the sensitive control of higher-order GVD. The present disclosure solves the technical problem of how wavenumber-selective coherent coupling (hereafter referred to simply as ‘coherent coupling’) between counterpropagating waves in a photonic crystal microresonator induces controlled frequency splittings that balance the underlying GVD to satisfy both equations (1) and (2). System 10 analyzes optical parametric oscillation (OPO), THG, and dispersive wave enhancement (DWE) in microcombs and FWM-BS by introducing coherent coupling into simulations of those systems and proves experimentally using the flexible example of μOPOs. Through the photonic crystal grating period, m values are dictated for the signal modes in three different μOPOs, and their tolerance to higher-order GVD is showcased by reproducing the same signal wavelength when pumping four separate modes of a single device. The generated signal wavelengths agree with simulations to within about 0.3%. The μOPOs are characterized by their threshold power and conversion efficiency and find that these measurements agree with a model based on the Lugiato-Lefever equation (LLE). The device 10 enables tuning the μOPO output frequencies continuously over 300 GHz without sacrificing efficiency or inducing mode hopping. The present disclosure re-envisions the design process for nonlinear wave-length converters, enables nonlinear optics in new spectral regions and with strongly dispersive materials, and invites fundamental studies of nonlinear physics in photonic crystal microresonators.

FIG. 1 depicts a system 10 that employs a photonic crystal microring resonator 130 and illustrates the four FWM processes studied. Silicon nitride (SiN (that is, Si₃N₄)) microrings where the ring width, RW′, varies along the inner boundary according to RW′=RW+A_{mod} cos (NO) where RW is the nominal ring width, A_{mod} is the photonic crystal grating modulation amplitude, N is the photonic crystal grating period (an integer) and θ is the resonator azimuthal angle. Therefore, the spatial period of modulation is 2πR/N, where R is the ring radius. The modulation creates a refractive index grating that coherently couples clockwise (CW) and counterclockwise (CCW) traveling-wave modes with the azimuthal number m=N/2, where m is an integer related to the wavenumber k via k=m/R. Hence, the coherent coupling is ‘wavenumber-selective’. The coupling rate, J, is proportional to A_{mod} and corresponds to half the frequency splitting between two supermodes, denoted ‘+’ and ‘−’ for the higher- and lower-frequency resonances, respectively (as pictured in the center of FIG. 1). This type of resonator has numerous functionalities, including sensing and the slowing of light. In the context of nonlinear optics, pump mode hybridization has been used to induce spontaneous pulse formation and facilitate parametric oscillations in resonators with normal GVD. Moreover, modulations with different N values can be combined to realize multi-wavelength dispersion engineering. In these experiments and others, J could be made larger than the resonator free spectral range (FSR) without reducing the quality factor.

The refractive index grating strength, which in some implementations is quantified by a spatial amplitude of the projections, is linked to the frequency spitting 2 J, and is chosen to compensate for the frequency mismatch between the modes involved in the nonlinear wavelength conversion process in the absence of the grating. The effect of the grating may be quantified by the splitting 2 J. In aspects, the splitting may be adjusted by varying one or more parameters associated with the amplitude of the grating, which can indeed be related to physical size. For example, for a photonic crystal ring with a sinusoidal grating, the amplitude of the sinusoid is a parameter associated with the amplitude of the grating. Typical modulation periods will be between 400 nm and 1000 nm, depending on the output wavelength of the nonlinear conversion process that is targeted, and typical modulation amplitudes will be between 5 nm and 100 nm, depending on the underlying dispersion and targeted output wavelength.

In aspects, the microring resonator 130 may have gratings where the refractive index changes without changing physical dimensions. For example, some materials (e.g., electro-optic materials) may be used for the microring resonator 130 that have an index that may be varied using electric fields in a periodic fashion. Materials whose refractive indexes can be varied with an electric field include Lithium Niobate (LiNbO₃), Potassium Dihydrogen Phosphate (KDP), Barium Titanate (BaTiO₃), Lead Lanthanum Zirconate Titanate (PLZT), liquid crystals, electro-optic polymers, and Gallium Arsenide (GaAs). In that case, the change in refractive index between the different regions of the grating would control the splitting. Typical modulation periods will be between 400 nm and 1000 nm, depending on the output wavelength of the nonlinear conversion process that is targeted, and typical refractive index modulation amplitudes will be between 0.01 and 0.2, depending on the underlying dispersion and targeted output wavelength.

μOPOs generate mono-chromatic signal and idler waves from a continuous-wave pump laser through resonantly enhanced degenerate FWM. Momentum conservation requires 2 mₚ=mₛ+mᵢ, where mₚ, mₛ and mᵢ are azimuthal numbers for the pump, signal and idler modes, respectively. Hence, mode pairs with m=mₚ±μ, where μ is an integer, may support μOPO if their resonance frequencies obey equation (1). In general, GVD prevents such frequency matching; that is, the associated FWM process does not conserve energy. To quantify this concept, the frequency mismatch is defined as:

$$Δ v = {v}_{μ} + {v}_{- μ} - 2 {v}_{0 ,} \qquad ( 3 )$$

where v₀ is the pump mode frequency and v_{μ} is the mode frequency associated with the azimuthal number mₚ+μ. Normal GVD gives Δv<0 for all u and thus prevents FWM. Nonetheless, applying an appropriate shift to v_{μ} (or v_{-μ}) will restore energy conservation and activate the μOPO, as illustrated by the blue lines in FIG. 1. This shift can be realized via the ‘+’ supermode; changing to the ‘+’ basis gives the transformation:

$$Δ {v}_{+} = \{ \begin{matrix}Δ {v}_{CW} + J , & m = \{ \frac{N}{2 , 2 {m}_{p}} - N / 2 \\ Δ {v}_{CW} , & else\end{matrix} \qquad ( 4 )$$

where Δv_{cw} is the frequency mismatch in the CW basis. Hence, mₛ is selected by choosing N=2 mₛ, and the μOPO is activated when J=−Δv_{cw}. Note that, from equation (3), Δv+(μ)=Δv₊(−μ); hence, the mismatch is shifted for both signal and idler modes. This approach can be compared with the case where N=2 mₚ, and a number of key differences are identified; namely, choosing N=2 mₛ improves the robustness, wavelength accuracy and tunability of the μOPO.

Coherent coupling in photonic crystal resonators can facilitate other FWM processes, as illustrated in FIG. 1. Specifically, the present disclosure explores THG, FWM-BS and DWE, all of which involve wide spectral gaps between their constituent wavelengths and thus exhibit Δv spectra that are difficult to control exclusively via the cross-sectional geometry of the microresonator. In each case, Δv can be re-defined according to equation (1) and use coherent coupling to restore energy conservation by balancing Δv_{cw} with J. Shifting the frequency of one mode can promote THG and FWM-BS. The DWE process merits special elaboration. Bright soliton microcombs operate in a regime of anomalous GVD, but certain wavelengths with normal GVD can exhibit local power enhancements (that is, DWE). The DWE phenomenon is useful to aid self-referencing, but the wavelengths of the dispersive waves are difficult to control due to their reliance on higher-order GVD. In another aspect of the present disclosure, wavenumber-selective coherent coupling may be used to dictate the m values of the dispersive waves. Because of the underlying anomalous GVD, the dispersive waves will be resonant with the ‘−’ supermode. This scheme could operate without tailoring higher-order GVD and deterministically select harmonic wavelengths for self-referencing, thus augmenting microcombs spectrally tailored with Fourier synthesis.

To prove these ideas, THG, FWM-BS and DWE in resonators with either purely normal (for THG and FWM-BS) or purely anomalous (for DWE) GVD are analyzed by including coherent coupling in the simulations of those systems. μOPO simulations are evaluated, where the model is verified with experiments. The present disclosure uses a set of coupled-mode equations to simulate THG and a pair of coupled LLEs to simulate FWM-BS and DWE. Coherent coupling is explicitly included in the models; that is, frequency shifts are not manually inserted into the GVD, since this would not account for the hybridization of the CW/CCW modes. The mode spectra is defined and simulations are performed in the CW/CCW basis. To include coherent coupling, one CW mode is allowed to exchange energy with its CCW counterpart at a coupling rate J that is continuously tunable.

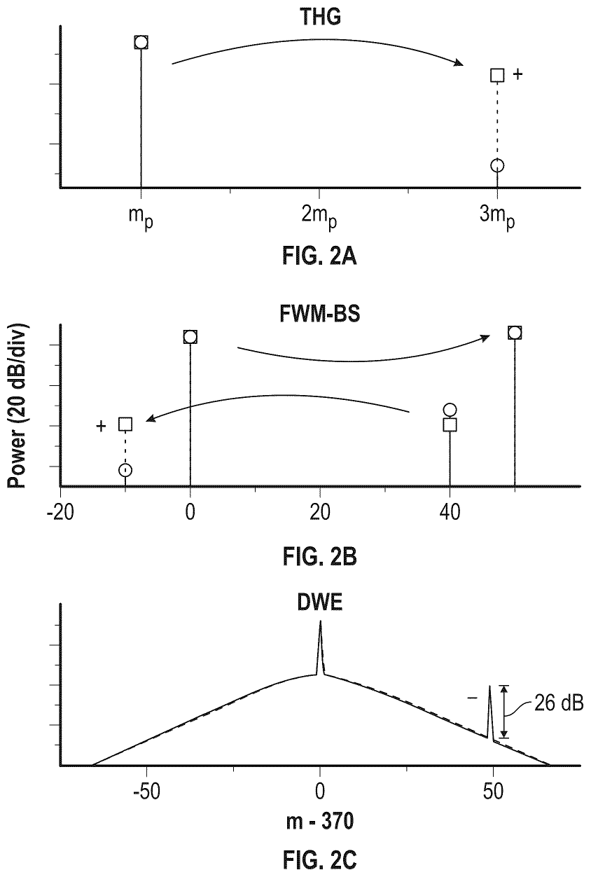

FIGS. 2A-2C, illustrates simulated optical spectra for THG, FWM-BS and DWE. In simulations, a (critically coupled) loaded linewidth κ/2π=500 MHz are assigned to all modes. In the THG simulations, Δv_{cw}=12.5 GHZ and Pᵢₙ=250 μW, where Pᵢₙ is the pump power. This Pᵢₙ value efficiently drives THG but is below the saturation power. Coherent coupling is applied to the third-harmonic mode. When J=0, the third-harmonic power P_{3H}≈2.7 nW. As a result, J=12.425 GHz maximizes P_{3H}, in accordance with equation (4), increasing it to P_{3H}≈3 μW, as shown in FIG. 2A.

To model FWM-BS, the present disclosure simulates a microresonator pumped by two separate pump lasers resonant with modes m=370 and m=420. For both lasers, Pᵢₙ=5 mW. A low-power input seed, resonant with mode m=410, is also injected into the resonator. FWM-BS converts the input seed photons to output signal photons resonant with m=360. D₂/2π is set such that D₂/2π=−25 MHz per mode, where D₂ is the second-order term in a Taylor series expression of the integrated dispersion, Dᵢₙₜ=v_{μ}−(v₀+μ×FSR). This D₂ value corresponds to Δv_{cw}=12.5 GHz. Coherent coupling is applied to the signal mode. When J=0, virtually no seed photons are converted. When J=12.6 GHZ, ˜25% of input photons are converted to wavelength-shifted output photons, as shown in FIG. 2B.

To simulate DWE, D₂/2π is set such that D₂/2π=10 MHz per mode and apply coherent coupling to the m=419 mode. A laser, resonant with mode m=370, pumps the resonator with Pᵢₙ=15 mW. When J=0, the micro-comb spectrum exhibits a smooth sech² profile with no DWEs. When J=13.75 GHz, the present disclosure observes a 26 dB power enhancement at the targeted mode, as shown in FIG. 2C.

To validate the main elements of this approach in experiments, an additional Kerr-nonlinear process is chosen, that of degenerately pumped μOPO. In processes such as THG and FWM-BS, the potential output wavelength is known a priori from the input wavelengths, with the efficiency of conversion depending on Δv (as well as other parameters not dependent on the phase and frequency-matching strategy, namely, resonator-waveguide coupling). By contrast, the μOPO output wavelengths are not determined solely by the input wavelengths but can vary widely depending on GVD. Therefore, μOPOs provide an ideal experimental test of wavenumber-selective FWM.

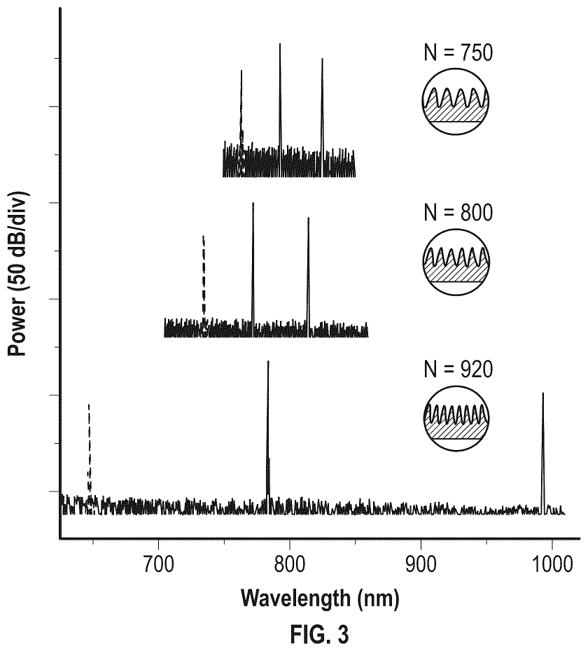

To this end, experiments that demonstrate a priori control over mₛ in μOPO devices with N=2 mₛ are performed. FIG. 3 presents optical spectra generated in three different photonic crystal micro-resonators with RW′ modulations parameterized by N=750, 800 and 920 and A_{mod}=5, 10 and 25 nm, respectively. In each device, A_{mod} is chosen to balance the underlying normal GVD (in the next section, the design process is explained in more detail). A fundamental transverse-electric (TEO) resonator mode near 780 nm is pumped and one of two outcomes is observed: a μOPO with mₛ=N/2 when J compensates for Δv_{cw} (that is, the three spectra in FIG. 3); or a CW state (that is, no wave-length conversion; data not shown in FIG. 3) preserved by normal GVD and an incommensurate balance of Δv_{cw} and J. The mₛ values from mode transmission spectroscopy are confirmed, and signal wavelengths of 763.5 nm (761.5 nm), 735.0 nm (735.8 nm) and 648.0 nm (649.9 nm) are measured (simulated). This binary distribution of measurement outcomes affirms the protected nature of wavelength conversion in these experiments.

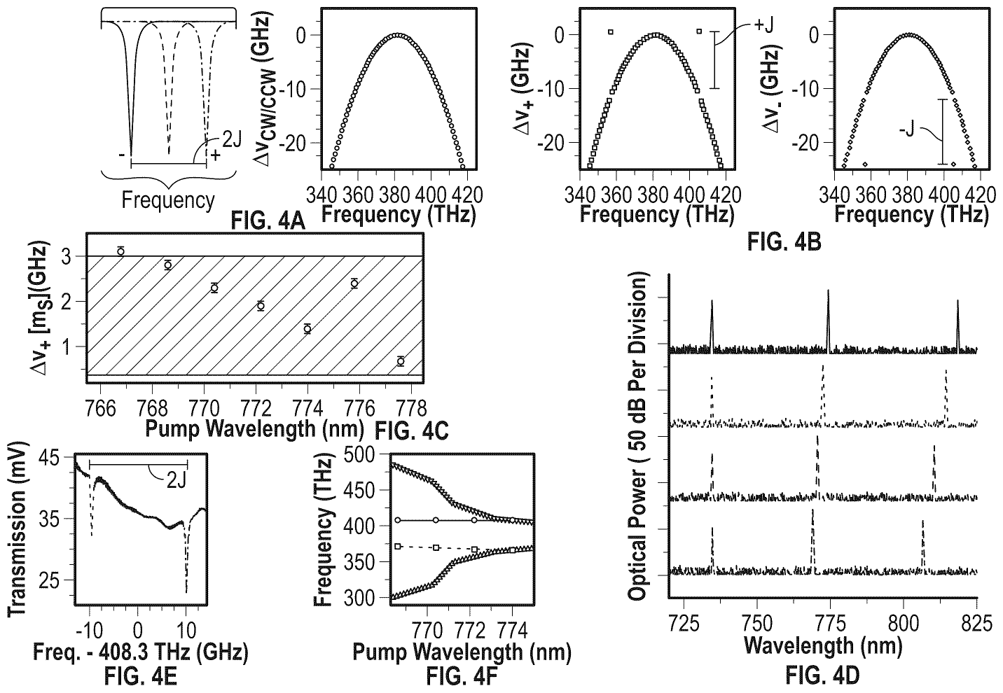

Another aspect of the present disclosure relates to procedures for designing photonic crystal microresonators and testing them post-fabrication (for details about the fabrication process. The μOPO mechanism is referred to as OPOSSUM, which stands for optical parametric oscillation using selective splitting in undulated microresonators. To start, the impact of wavenumber-selective coherent coupling on the resonator mode spectrum is reiterated: CW and CCW modes with m=N/2 hybridize into two supermodes with frequency separation 2 J, as illustrated in FIG. 4A. Hence, OPOSSUM devices exhibit three Δv spectra, denoted Δv_{cw/ccw}, Δv₊ and Δv−, depending on the basis used. To choose values for RW, N and A_{mod} (the SiN thickness H is fixed by the current stock of SiN and R=25 μm), mode spectra is simulated using the finite-element method for devices without RW′ modulation. Δv_{cw} is calculated according to equation (3) and an RW value is chosen that exhibits broadband normal GVD. Then, a target signal wavelength (for example, 760 nm, 735 nm or 650 nm for the three devices related to FIG. 3B) is identified and N is chosen accordingly. To select A_{mod}, a set of devices are fabricated with variations in RW, A_{mod} and N, and the frequency splittings to calibrate J(N, RW, A_{mod}) are measured. Using these calibrations, A_{mod} is set for a particular device to balance Δv_{cw}.

FIG. 4B depicts the simulated Δv_{cw/ccw}, Δv₊ and Δv-spectra for a device with RW=925 nm, H=600 nm and N=800. Notably, the Δv₊ spectrum is discontinuous at the signal and idler frequencies, where Δv+=Δv_{cw}+J(note that, even though coherent coupling is only applied to the signal mode, the Δv₊ values are shifted equally for signal and idler modes because, according to equation (3), Δv+(μ)=Δv+(−μ)). This suggests that OPOSSUM suppresses FWM involving modes other than the targeted signal and idler, since at these frequencies the resonator exhibits strong normal dispersion.

The OPOSSUM device simulated in FIGS. 4A-F was fabricated and the TEO mode wavelengths were measured to calculate Δv₊[mₛ] (that is, the value of Δv₊ at the targeted signal mode). Δv₊[mₛ] depends on mₚ. Tuning the pump wavelength can correct for fabrication uncertainties and, more generally, ensure reliable operation. To concretize this idea, the present disclosure measures Δv₊[mₛ] versus the pump wavelength, as shown in FIG. 4D. Results illustrate that Δv₊[mₛ] decreases with increasing pump wavelength, with an exception near 776 nm, where mode crossings at the pump as well as idler wavelengths are observed. In principle, a OPO can be generated using any pump mode such that Δv₊[mₛ]>0, provided that Pᵢₙ is large enough to induce compensating nonlinear mode frequency shifts. Realistically, however, it is preferred that Δv₊[mₛ] to be <3 GHz. Greater Δv₊ values require Pᵢₙ>50 mW to produce appreciable signal and idler powers; at this level, absorption-induced temperature shifts can destabilize the μOPO. At the same time, Δv₊[mₛ]>κ/4π is required. In the OPOSSUM devices, typical loaded quality factor (Q) values between 5×10⁵ and 7×10⁵ (with some dependence on wavelength) are measured, so the four pump modes spanning wavelengths 768-774 nm satisfy these requirements, as indicated in FIG. 4C. Indeed, pumping any of these modes results in a μOPO. The optical spectra are recorded and presented in FIG. 4D. As expected, mₛ is fixed-its value is protected by the wavenumber-selective coherent coupling, with an example transmission spectrum shown in FIG. 4D. In FIG. 4E, measurements of the signal and idler frequencies (vₛ and vᵢ, respectively) versus the pump wavelength are presented. Similar data (pale stripes), is overlayed for a μOPO system that relies on higher-order GVD, where the dispersion sensitivity is apparent from the large shifts in vₛ and vᵢ when tuning the pump laser between adjacent pump modes (that is, with consecutive mₚ values). By comparison, OPOSSUM is a robust mechanism for targeting specific wavelengths.

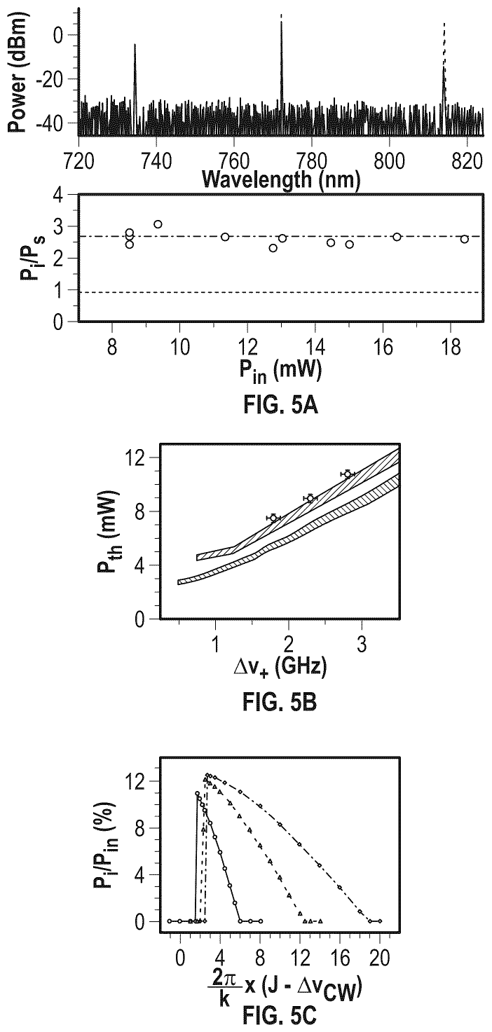

Next, the OPOSSUM efficiency and threshold behavior are investigated. To model OPOSSUM, a pair of coupled LLEs are simulated that describe the intraresonator evolution of the CW and CCW fields. The present disclosure being specifically interested in connections between the experimental parameters and the power generated in the signal and idler waves. Intuitively, it is expected that the signal wave, which occupies the ‘+’ supermode, to propagate in both CW and CCW directions; hence, some signal light should be detected at the input (reflection) port of a device, as shown in FIG. 1. In simulations, approximately 20% more signal power in the reflection port than the transmission port is observed. This distribution is approximately independent of Pᵢₙ and Δv+. In experiments, an approximately equal distribution of signal power to the two ports were measured. The FIG. 4A shows the optical spectra calibrated to estimate the on-chip power levels at the transmission and reflection (purple) ports of the OPOSSUM device characterized in FIG. 1. The presence of reflected pump and idler light is due to Fresnel reflections at the waveguide facets, but such light is still strongly suppressed relative to the transmission port (for example, ˜20 dB for the idler). Ultimately, large optical losses that occur during propagation from the reflection port to the optical spectrum analyzer prevent a precise measurement of the signal power distribution. A more precise comparison can be made between the transmitted powers of the signal and idler waves, denoted Pₛ and Pᵢ, respectively. Specifically, calculate Pᵢ/Pₛ versus Pᵢₙ and indicate the measurements with blue data points in the bottom panel of FIG. 5A. The measurements agree with simulation results shown by the orange dashed line. Notably, it is found that Pᵢ/Pₛ does not depend on Pᵢₙ. Moreover, the unequal distribution of photons between signal and idler waves is unique within the Kerr microring resonator platform-previous (non-OPOSSUM) μOPO systems exhibited an equal distribution of photons ensured by the symmetry of degenerate FWM. In OPOSSUM, this symmetry is broken by CW/CCW coupling. Finally, signal light propagating in the CW/CCW directions can be coherently re-combined outside the resonator to increase Pₛ.

To characterize OPOSSUM further, the threshold power for parametric oscillation (Pₜₕ) is measured, which is another parameter of μOPO systems. Conveniently, Pₜₕ versus Δv₊ can be measured by choosing different pump modes, as shown in FIG. 5A. The Pₜₕ values predicted from the model are shown by the blue stripe, and the Pₜₕ values predicted from a crude model (consisting of a single LLE where the signal mode frequency is shifted by J) are shown by the grey stripe. Measurements support the validity of this model.

Next, the robustness of OPOSSUM with respect to variation in J are reviewed. Such an investigation conveys the design tolerance of OPOSSUM, that is, the allowable errors in device geometry that can arise from fabrication uncertainties. Specifically, OPOSSUM is stimulated and calculate the conversion efficiency (Pᵢ/Pᵢₙ) versus J for Pᵢₙ=10, 20 and 30 mW, as shown in FIG. 5B. It is found that the maximum conversion efficiency is 12.5% for a critically coupled resonator, which is the same result derived recently for other μOPO systems (the maximum conversion efficiency can be increased by over coupling the resonator, at the cost of greater Pₜₕ). Moreover, the range of J values that supports a given efficiency increases with Pᵢₙ. For instance, to realize Pᵢ≥2 mW with Pᵢₙ=20 mW, 22≤2 J≤25 GHz is found, where κ/2π=500 MHz and Δv_{cw}=10 GHz. For the device characterized in FIG. 5C, this corresponds roughly to 11≤A_{mod}≤12.5 nm. The possibility of increasing design tolerances using, for example, temperature tuning, requires further study.

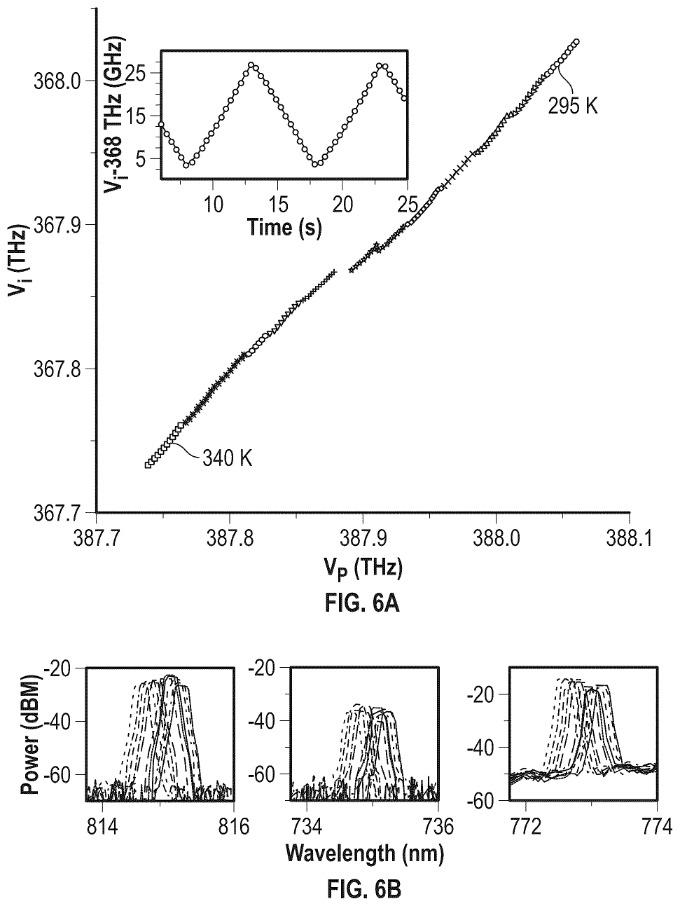

Finally, the wavelength tunability of OPOSSUM is evaluated using the same device characterized in FIGS. 4 and 5. Such tunability is practical to nonlinear wavelength converters aiming for, for example, specific atomic transitions. In the present disclosure, the pump frequency vₚ by about 25 GHz is swept while sustaining a μOPO, and observe the resulting changes in vᵢ using a wavemeter (vₛ can be inferred from vᵢ and vₚ using equation (1)). An example of this data is shown in FIG. 6A. It is found that dv₁/dp≈1. To extend the wavelength access of the OPOSSUM device, its temperature T is increased according to dv₀/dT≈≈−4 GHZ K⁻¹ and repeated the vₚ sweep while recording v₁. FIG. 6 illustrates results from repeating this measurement at 11 different temperatures, from T≈295-340 K, chosen to access all frequencies between 367.73≤vᵢ≤368.02 THz. At some temperatures, it was found that vₚ could be swept >25 GHz while sustaining the μOPO. This is why some colors comprise more frequencies than others in FIGS. 6A and B. At each temperature, the optical spectrum is recorded, as shown in FIG. 6B where the idler, signal and pump bands in the left, middle and right panels, respectively, are magnified. The μOPO output power is maintained across the entire tuning range. Moreover, the nearly 300 GHz of tuning reported here was only limited by instabilities in the setup at the higher temperatures. Given such stability, it is expected that greater tuning ranges, possibly exceeding the FSR, are attainable. These measurements suggest that a suitable choice of N, combined with continuous tunability, gives deterministic wavelength control with high accuracy.

Through the OPOSSUM mechanism, 99.7% wavelength accuracy without iterating fabrication runs is achieved (that is, to target specific wavelengths, N values are identified based only on finite-element simulations, with little guidance from previous measurements). Moreover, temperature tuning beyond the approximately 50 K range that can be achieved in experiments will compensate for wavelength inaccuracies. In cases where Δv₊ depends on T, one can leverage the relationship between Δv₊ and mₚ. For instance, if T must be adjusted so much that a μOPO is destabilized when pumping mode mₚ, then switching to mₚ±1 (depending on whether T has been increased or decreased) will restore frequency matching.

In conclusion, the present disclosure illustrates that coherent coupling in photonic crystal resonators can facilitate FWM-based nonlinear wavelength conversion without higher-order GVD. The present disclosure investigated four χ⁽³⁾ processes within such resonators: FWM-BS, THG, DWEs in microcombs and OPO. In all cases it is found that large efficiencies could be achieved for a specific targeted mode, establishing a basis for wavelength accuracy in Kerr-nonlinear photonics, and future optimization of the method should lead to even larger efficiencies than reported here. Moreover, it was explored how the photonic crystal structure gives excellent control over generated wavelengths while protecting the FWM process from unwanted non-linear couplings. To affirm the simulation results, experimental focus was on the specific case of OPO, which is typically distinguished by a substantial sensitivity of the output wavelengths to the device geometry and pump wavelength. μOPOs were generated with signal wavenumbers defined by the photonic crystal grating period. The conversion efficiencies and threshold powers for multiple devices were measured, and these measurements agreed with the simulations. Finally, the present disclosure demonstrated continuous tunability of the μOPO spectrum. Coherent coupling can be implemented in resonant χ⁽²⁾-nonlinear systems, in addition to the χ⁽³⁾ systems discussed here. The devices and methods introduced here will be invaluable to future nanotechnologies that utilize application-tuned and wavelength-accurate nonlinear photonics. In particular, the methods introduced here are relevant to other nonlinear processes such as third-order sum and difference frequency generation, stimulated four-wave mixing, DC-field-induced second harmonic generation, second harmonic generation (without a DC field), sum and difference frequency generation based on the χ⁽²⁾ nonlinearity, and optical parametric oscillation based on the χ⁽²⁾ nonlinearity.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for wavelength-accurate conversion, comprising:
a light source configured to pump a first color laser light; and
a device configured for Kerr-nonlinear wavelength conversion of the first color laser light to a signal laser light and an idler laser light, the device including:
a waveguide configured to couple to the light source; and
a microring resonator coupled to the light source via the waveguide, the microring resonator configured to generate the signal laser light and the idler laser light, the microring resonator including a plurality of surfaces, wherein at least one of the plurality of surfaces includes a plurality of projections, wherein a number of the projections is linked to a targeted output wavelength for at least one of the signal laser light or the idler laser light, and a refractive index grating strength of each projection of the plurality of projections is linked to a frequency mismatch between modes when compared to a reference device lacking the plurality of projections.

2. The system of claim 1, wherein at least one of the plurality of surfaces includes:
an inner surface defining an annular bore;
an outer surface opposite the inner surface;
a top surface; and
a bottom surface opposite the top surface and disposed on a substrate.

3. The system of claim 2, wherein the plurality of projections radially project from the inner surface, wherein the plurality of projections define an angle between each projection of the plurality of projections, and wherein the angle between each projection of the plurality of projections is two times pi times a radius of the microring resonator divided by a number of the plurality of projections (N).

4. The system of claim 1, wherein the plurality of projections are configured to create a refractive index grating that coherently couples clockwise (CW) and counterclockwise (CCW) traveling-wave modes with an azimuthal number m=N/2, where m is an integer related to a wavenumber k via k=m/R, wherein the coherent coupling introduces a frequency splitting of the CW and CCW modes with azimuthal number m by an amount 2 J.

5. The system of claim 4, wherein the azimuthal number m is selected based on the targeted output wavelength of the Kerr-nonlinear wavelength conversion linking the targeted output wavelength to the number of the plurality of projections (N).

6. The system of claim 4, wherein the refractive index grating strength is linked to the frequency spitting 2 J, and is chosen to compensate for the frequency mismatch between the modes involved in the Kerr-nonlinear wavelength conversion process when compared to a reference device lacking the plurality of projections.

7. The system of claim 2, wherein the plurality of projections project radially outward from at least one of the outer surface or the top surface.

8. The system of claim 1, further comprising a heater configured for tuning a frequency of the signal laser light.

9. The system of claim 1, wherein the system is configured for performing at least one of: four-wave mixing Bragg scattering, third harmonic generation, dispersive wave emission in microresonator frequency combs, third-order sum and difference frequency generation, stimulated four-wave mixing, DC-field-induced second harmonic generation, second-order (chi(2)) nonlinear processes, including at least one of second harmonic generation, sum and difference frequency generation, or chi(2) OPO.

10. A device for wavelength-accurate conversion, comprising:
a waveguide configured to couple to a light source; and
a microring resonator coupled to the light source via the waveguide, the microring resonator configured to generate a signal laser light and an idler laser light, the microring resonator including a plurality of surfaces, wherein at least one of the plurality of surfaces includes a plurality of projections, wherein a number of the projections is linked to a targeted output wavelength for at least one of the signal laser light or the idler laser light, and a refractive index grating strength of each projection of the plurality of projections is linked to a frequency mismatch between modes when compared to a reference device lacking the plurality of projections.

11. The device of claim 10, wherein the plurality of projections are configured to create a refractive index grating that coherently couples clockwise (CW) and counterclockwise (CCW) traveling-wave modes with an azimuthal number m=N/2, where m is an integer related to a wavenumber k via k=m/R, wherein the coherent coupling introduces a frequency splitting of the CW and CCW modes with azimuthal number m by an amount 2 J.

12. The device of claim 11, wherein the azimuthal number m is selected based on the targeted output wavelength of the Kerr-nonlinear wavelength conversion linking the targeted output wavelength to the number of the plurality of projections (N).

13. The device of claim 12, wherein the refractive index grating strength is linked to the frequency spitting 2 J, and is chosen to compensate for the frequency mismatch between the modes involved in the Kerr-nonlinear wavelength conversion process when compared to a reference device lacking the plurality of projections.

14. A method for wavelength-accurate conversion, comprising:
receiving by a waveguide a first color laser light from a laser source;
coupling the laser source to a microring resonator via the waveguide, the microring resonator including a plurality of surfaces, wherein at least one of the plurality of surfaces includes a plurality of projections;
perform Kerr-nonlinear wavelength conversion of the first color laser light to a signal laser light and an idler laser light;
linking a number of projections of the plurality of projections to a targeted output wavelength for at least one of the signal laser light or the idler laser light; and
linking a refractive index grating strength of each projection of the plurality of projections to a frequency mismatch between modes when compared to a reference device lacking the plurality of projections.

15. The method of claim 14, wherein the plurality of projections radially project from an inner surface of the microring resonator, wherein the plurality of projections define an angle between each projection of the plurality of projections, and wherein the angle between each projection of the plurality of projections is two times pi times a radius of the microring resonator divided by a number of the plurality of projections.

16. The method of claim 14, further comprising:
coherently coupling clockwise (CW) and counterclockwise (CCW) traveling-wave modes with an azimuthal number m=N/2, where m is an integer related to a wavenumber k via k=m/R, wherein the coherent coupling introduces a frequency splitting of the CW and CCW modes with azimuthal number m by an amount 2 J.

17. The method of claim 14, wherein the plurality of projections project radially outward from at least one of an outer surface or a top surface of the microring resonator.

18. The method of claim 14, further comprising:
tuning a frequency of the signal laser light by a heater configured to heat the microring resonator.

19. The method of claim 14, further comprising:
using the microring resonator to perform at least one of: four-wave mixing Bragg scattering, third harmonic generation, dispersive wave emission in microresonator frequency combs, third-order sum and difference frequency generation, stimulated four-wave mixing, DC-field-induced second harmonic generation, second-order (chi(2)) nonlinear processes, including at least one of second harmonic generation, sum and difference frequency generation, or chi(2) OPO.

20. The method of claim 14, further comprising:
selecting the azimuthal number m based on the targeted output wavelength of the Kerr-nonlinear wavelength conversion process linking the targeted output wavelength to the number of the plurality of projections (N).
